(19) United States
(12) Patent Application Publication
(10) Pub. No.: US 2010/0055502 A1
(43) Pub. Date: Mar. 4, 2010

(54) TUNNELING MAGNETORESISTIVE DEVICE

(75) Inventors: Hitoshi KUBOTA, Ibaraki (JP); Akio FUKUSHIMA, Ibaraki (JP); Kei YAKUSHIJI, Ibaraki (JP); Shinji YUASA, Ibaraki (JP); Koji ANDO, Ibaraki (JP); Satoshi YAKATA, Ibaraki (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Nat Inst of Adv Industrial Sci and Tech, Chiyoda-ku (JP)

(21) Appl. No.: 12/547,978

(22) Filed: Aug. 26, 2009

(30) Foreign Application Priority Data
Aug. 29, 2008 (JP) 2008-222753
Jul. 3, 2009 (JP) 2009-158982

(51) Int. Cl. G11B 5/66; G11B 5/33

(52) U.S. Cl. 428/827; 428/800

(57) ABSTRACT

A tunneling magnetoresistive device includes: a fixed layer that includes a ferromagnetic material; a tunneling insulating film that is provided in contact with the fixed layer; and a free layer that includes a first ferromagnetic film provided in contact with the tunneling insulating film, a second ferromagnetic film whose magnetization is coupled parallel to the magnetization of the first ferromagnetic film, and a conductive film interposed between the first ferromagnetic film and the second ferromagnetic film.

### BACKGROUND OF THE INVENTION

1. Field of the Invention

The present invention generally relates to a tunneling magnetoresistive device, and more particularly, to a tunneling magnetoresistive device including two parallel-coupled ferromagnetic films that form a free layer.

2. Description of the Related Art

Tunneling magnetoresistive (TMR) devices are used in a MRAM (Magnetoresistive Random Access Memory), for example. Each tunneling magnetoresistive device has a tunneling insulating film interposed between two ferromagnetic films. Of the two ferromagnetic films, the ferromagnetic film that has a magnetization direction easily reversed when a magnetic field is applied is the free layer, and the ferromagnetic film that has a magnetization direction not easily reversed is the fixed layer. In a MRAM, for example, data can be written in a nonvolatile manner, depending on the magnetization direction of the free layer. In recent years, attention is drawn to a spin injection technique as a technique for causing a spin reversal in a free layer. According to this technique, spin-polarized carriers are injected so as to reverse the magnetization of a free layer. For example, the spin injection technique is utilized in a MRAM, so that data can be written without a magnetic field. Accordingly, the memory cell area can be made smaller. Also, according to the spin injection technique, the smaller the tunneling magnetoresistive device, the smaller the switching current required for writing data. Accordingly, the memory cells can be made smaller, and the current consumption can be reduced.

Japanese Unexamined Patent Publication No. 2007-294737 discloses a tunneling magnetoresistive device that includes a multilayer-type free layer formed with two ferromagnetic films in which antiparallel interlayer exchange coupling is observed in magnetization. According to Japanese Unexamined Patent Publication No. 2007-294737, higher thermal stability is achieved by the antiparallel coupling between the two ferromagnetic films.

In tunnel magnetoresistive devices, a further reduction in the switching current at the time of spin injection is expected, and higher thermal stability is demanded. However, in the tunneling magnetoresistive device disclosed in Japanese Unexamined Patent Publication No. 2007-294737, the reduction in the switching current and the increase in the thermal stability are insufficient.

### SUMMARY OF THE INVENTION

It is therefore an object of the present invention to provide a tunneling magnetoresistive device in which the above disadvantage is eliminated.

A more specific object of the present invention is to provide a tunneling magnetoresistive device that can achieve both a sufficient reduction in the switching current and a sufficient increase in the thermal stability.

According to an aspect of the present invention, there is provided a tunneling magnetoresistive device including: a fixed layer that includes a ferromagnetic material; a tunneling insulating film that is provided in contact with the fixed layer; and a free layer that includes a first ferromagnetic film provided in contact with the tunneling insulating film, a second ferromagnetic film with magnetization that is interlayer-exchange-coupled parallel to the first ferromagnetic film, and a conductive film interposed between the first ferromagnetic film and the second ferromagnetic film. In accordance with the present invention, a tunneling magnetoresistive device that can achieve both a reduction in the switching current and an increase in the thermal stability can be provided.

As described above, the present invention can provide a tunneling magnetoresistive device that can achieve both a reduction in the switching current and an increase in the thermal stability.

### BRIEF DESCRIPTION OF THE DRAWINGS

Other objects, features and advantages of the present invention will become more apparent from the following detailed description when read in conjunction with the accompanying drawings, in which:

FIG. 1 is a cross-sectional view for explaining the principles of the present invention;

FIG. 2 is a cross-sectional view of a single-layer sample;

FIG. 3 is a cross-sectional view of a parallel-coupled or antiparallel-coupled sample;

FIGS. 4A and 4B are diagrams for explaining a measurement technique;

FIG. 5 is a graph showing the switching current characteristics of magnetoresistance;

FIG. 6 is a cross-sectional view of a sample;

FIG. 7 shows the magnetization curve observed where there is antiparallel coupling in the sample shown in FIG. 6;

FIG. 8 shows the magnetization curve observed where there is parallel coupling in the sample shown in FIG. 6;

FIG. 9 is a cross-sectional view of another sample;

FIGS. 10A through 10D show magnetization curves of the sample shown in FIG. 9;

FIG. 11 is a graph showing the dependency of the saturation magnetic field and loop shift on the film thickness of the conductive film;

FIG. 12 is a graph showing the dependency of the saturation magnetic field of the sample shown in FIG. 6 on the film thickness of the conductive film;

FIG. 13 is a graph showing the resistance of a tunneling magnetoresistive device with respect to magnetic field;

FIG. 14A is a graph showing the switching probability with respect to the magnetic field for switching from a parallel state to antiparallel state;

FIG. 14B is a graph showing the switching probability with respect to the magnetic field for switching from an antiparallel state to a parallel state;

FIG. 15 is a schematic view illustrating measurement according to a magnetic field reversal technique;

FIG. 16 is a graph showing a voltage with respect to time observed with an oscilloscope;

FIG. 17 is a graph showing the switching probability with respect to time;

FIGS. 18A and 18B are graphs showing the effective thermal stability with respect to magnetic field;

FIG. 19 is a graph showing the effective thermal stability with respect to current;

FIGS. 20A through 20C are schematic views of a sixth embodiment of the present invention;

FIG. 21 is a graph showing the resistance with respect to magnetic field; and

FIGS. 22A through 22E are graphs showing the voltage fluctuations with time in the cases of (a) through (e) shown in FIG. 21.

### DESCRIPTION OF THE PREFERRED EMBODIMENTS

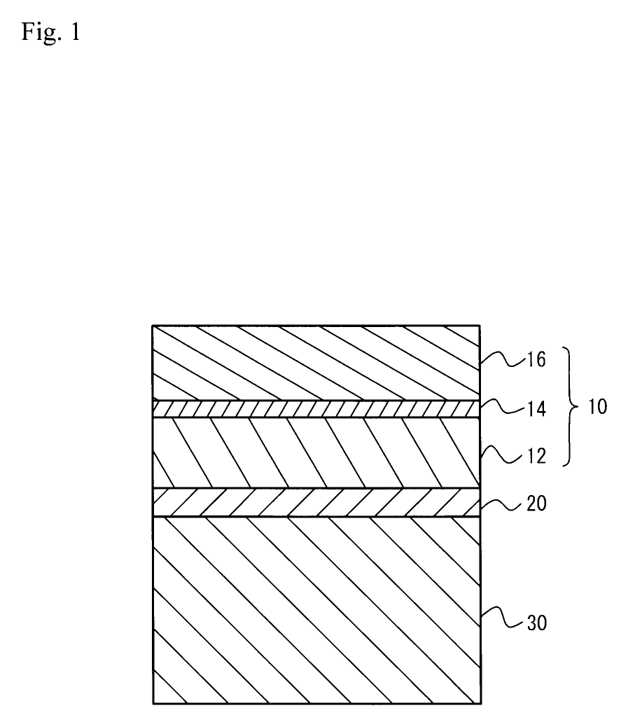

FIG. 1 is a schematic view for explaining the principles of the present invention. A tunneling magnetoresistive device of the present invention includes a fixed layer 30 having a ferromagnetic body, a tunneling insulating film 20 provided in contact with the fixed layer 30, and a free layer 10 provided in contact with the tunneling insulating film 20. The free layer 10 includes a first ferromagnetic film 12 provided in contact with the tunneling insulating film 20, a second ferromagnetic film 16 ferromagnetically coupled parallel to the first ferromagnetic film 12, and a conductive film 14 interposed between the first ferromagnetic film 12 and the second ferromagnetic film 16.

The fixed layer 30 may be a single-layer ferromagnetic film, or may be a multilayer film that has ferromagnetic films interposing a nonmagnetic conductive film. The tunneling insulating film 20 may be a magnesium oxide (MgO) film, for example, or may be some other insulating film. The first ferromagnetic film 12 and the second ferromagnetic film 16 may be CoFeB films each having the body-centered cubic structure containing Co, Fe, and B, which is disclosed in Japanese Unexamined Patent Publication No. 2007-294737.

Next, the reason that higher thermal stability can be achieved with the present invention is described. Thermal stability is the stability required for the free layer 10 not to have its magnetization direction reversed. If the thermal stability is poor, MRAM data is erased in a short time, for example. To restrict the power consumption, it is preferable that the magnetization of the free layer 10 is reversed with a small switching current at the time of spin injection. To do so, it is effective to reduce the magnetization and the volume of the free layer 10. However, the thermal stability becomes poorer at the same time. There is a trade-off relationship between the switching current and the thermal stability. As an index of thermal stability, a thermal stability index Δ is used. The thermal stability index Δ is the index relative to the energy barrier obtained when magnetization is reversed, and is expressed by the following formula 1:

$$Δ = \frac{{E}_{u}}{{k}_{B} T} \qquad [ Formula 1 ]$$

where Eᵤ represents the uniaxial magnetic anisotropy energy, k_{B} represents the Boltzmann's constant, and T presents the temperature. As the thermal stability index Δ is greater, the thermal stability is higher.

As shown in the formula 2 below, the uniaxial magnetic anisotropy energy Eᵤ is represented by the sum of the shape magnetic anisotropy energy Eᵤ^{shape} and the remaining magnetic anisotropy energy Eᵤ^{film}. Here, the remaining magnetic anisotropy energy Eᵤ^{film} is equivalent to all the magnetic anisotropy energy other than the shape magnetic anisotropy energy Eᵤ^{shape} such as magnetic crystalline anisotropy energy and induced magnetic anisotropy energy.

Eᵤ=Eᵤ^{film}+Eᵤ^{shape} [Formula 2]

Table 1 shows the shape magnetic anisotropy energy Eᵤ^{shape} observed in a case where the free layer 10 is a single-layer ferromagnetic film, a case where the free layer 10 is a multiplayer formed with the first ferromagnetic film 12 and the second ferromagnetic film 16, in which parallel interlayer exchange coupling in magnetization (parallel coupling), and a case where the free layer 10 is a multilayer in which antiparallel interlayer exchange coupling in magnetization (antiparallel coupling) is observed between the first ferromagnetic film 12 and the second ferromagnetic film 16. In Table 1, N represents the difference between the demagnetizing field coefficient of the long axis direction and the demagnetizing field coefficient of the short axis direction of the cells in the free layer 10, M₁ represents the magnetization of the first ferromagnetic film 12 or the single-layer ferromagnetic film, M₂ represents the magnetization of the second ferromagnetic film 16, V₁ represents the volume of the first ferromagnetic film 12 or the single-layer ferromagnetic film, V₂ represents the volume of the second ferromagnetic film 16, d₁ represents the film thickness of the first ferromagnetic film 12 or the single-layer ferromagnetic film, and d₂ represents the film thickness of the second ferromagnetic film 16.

TABLE 1

| | Eu^{shape} |
|---|---|
| SINGLE LAYER | (1/2)N(M₁)²V |
| PARALLEL COUPLING | $( 1 \text{/} 2 ) {N ( \frac{{M}_{1} {d}_{1} + {M}_{2} {d}_{2}}{{d}_{1} + {d}_{2}} )}^{2} ( {V}_{1} + {V}_{2} )$ |
| ANTIPARALLEL COUPLING | $( 1 \text{/} 2 ) {N ( \frac{{M}_{1} {d}_{1} - {M}_{2} {d}_{2}}{{d}_{1} + {d}_{2}} )}^{2} ( {V}_{1} + {V}_{2} )$ |

The switching current is the current for causing a reverse in the first ferromagnetic film 12. Therefore, the switching current depends on the magnetization M₁, and can be made smaller by reducing the magnetization M₁. Where the magnetization M₁ is a fixed value in two structures, the structure having the greater shape magnetic anisotropy energy Eᵤ^{shape} also has the greater uniaxial magnetic anisotropy energy Eᵤ and the greater thermal stability index Δ. In other words, a desirable switching current and excellent thermal stability can be achieved at the same time.

As shown in Table 1, in the case of antiparallel coupling, the shape magnetic anisotropy energy Eᵤ^{shape} is proportional to the square of (M₁d₁−M₂d₂)/(d₁+d₁). In the case of parallel coupling, on the other hand, the shape magnetic anisotropy energy Eᵤ^{shape} is proportional to the square of (M₁d₁+M₂d₂)/(d₁+d₁). Accordingly, the structure in which the first ferromagnetic film 12 and the second ferromagnetic film 16 are in a parallel-coupled state has a greater shape magnetic anisotropy energy Eᵤ^{shape} than that of the structure in which the first ferromagnetic film 12 and the second ferromagnetic film 16 are in an antiparallel-coupled state. Thus, it is most probable that both a desirable switching current and excellent thermal stability can be achieved simultaneously in the case of parallel coupling.

As described above, the shape magnetic anisotropy energy Eᵤ^{shape} affects the thermal stability index Δ, when the shape magnetic anisotropy energy Eᵤ^{shape} is dominant in the uniaxial magnetic anisotropy energy Eᵤ. Therefore, it is preferable that the shape magnetic anisotropy energy Eᵤ^{shape} is greater than the remaining magnetic anisotropy energy Eᵤ^{film}.

Based on the conventional technical knowledge, increases both in the switching current and thermal stability are predicted where parallel interlayer exchange coupling is observed between the magnetization of the first ferromagnetic film 12 and the magnetization of the second ferromagnetic film 16 in the free layer 10. This is because the free layer 10 having two parallel-coupled ferromagnetic films interposing the conductive film 14 is considered to behave like a free layer that is virtually a single thick ferromagnetic film having the two ferromagnetic films in direct contact with each other without the conductive film 14. Where the film thickness of a free layer formed with a single ferromagnetic film is increased, the switching current and the thermal stability also become greater at the same time. To counter this problem, the present invention employs the free layer 10 in which parallel interlayer exchange coupling is observed between the magnetization of the first ferromagnetic film 12 and the magnetization of the second ferromagnetic film 16, so as to reduce the switching current and improve the thermal stability at the same time, as described above. In the following, embodiments of the present invention are described.

### First Embodiment

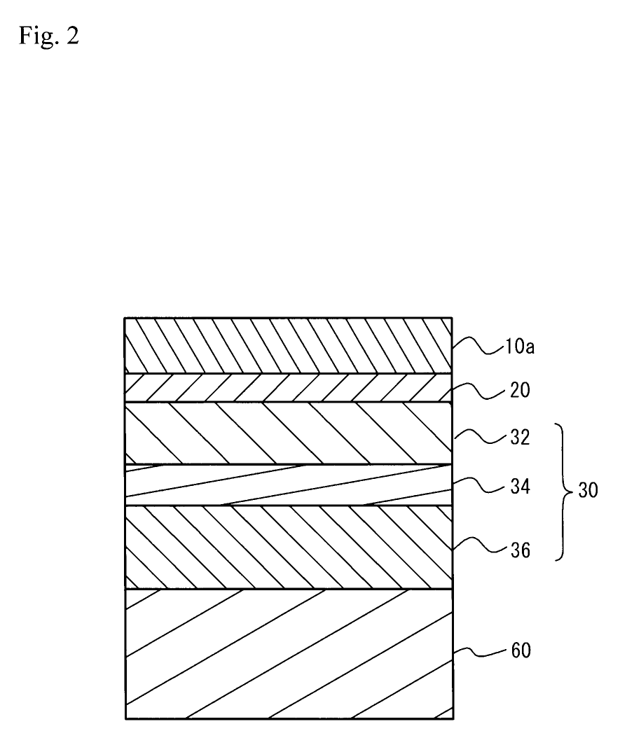

A sample (single-layer sample) having a single-layer ferromagnetic film as the free layer 10, a sample (a parallel-coupled sample; this sample is the first embodiment) having the first ferromagnetic film 12 and the second ferromagnetic film 16 coupled parallel to each other, and a sample (an antiparallel-coupled sample) having the first ferromagnetic film 12 and the second ferromagnetic film 16 coupled antiparallel to each other are formed. FIG. 2 is a cross-sectional view of the single-layer sample. The fixed layer 30 is formed on a PtMn film 60 of 15 nm in film thickness. The fixed layer 30 includes a third ferromagnetic film 36 that is a 2.5-nm thick CoFe film formed on the PtMn film 60, a second conductive film 34 formed with a 0.85-nm thick Ru film, and a fourth ferromagnetic film 32 formed with a 3-nm thick CoFeB film. The tunneling insulating film 20 that is a 1-nm thick MgO film is formed on the fourth ferromagnetic film 32 of the fixed layer 30. A single-layer free layer 10a that is a 2-nm thick CoFeB film is formed on the tunneling insulating film 20. The magnetization of the CoFeB is approximately 1.4 T.

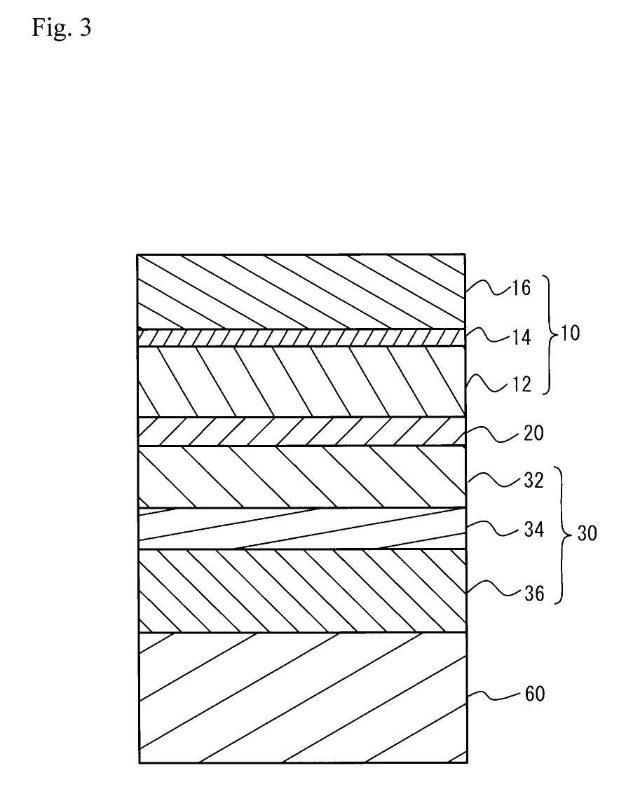

FIG. 3 is a cross-sectional view of the parallel-coupled sample and the antiparallel-coupled sample. The part of the structure between the PtMn film 60 and the tunneling insulating film 20 is the same as that of the single-layer sample, and therefore, explanation of it is omitted herein. The free layer 10 is formed on the tunneling insulating film 20. The free layer 10 includes the first ferromagnetic film 12 formed with a 2-nm thick CoFeB film, the conductive film 14 formed with a Ru film, and the second ferromagnetic film 16 formed with a 2-nm thick CoFeB film. In the parallel-coupled sample, the film thickness of the conductive film 14 is 1.3 nm. In the antiparallel-coupled sample, the film thickness of the conductive film 14 is 1.1 nm. The formation of a parallel-coupled or antiparallel-coupled sample with the conductive film 14 having such a thickness will be explained later in the third embodiment. Each layer in each of those samples is formed by a magnetron sputtering technique. The cross-section shape of the tunneling magnetoresistive device is an elliptic shape of 90 nm×140 nm.

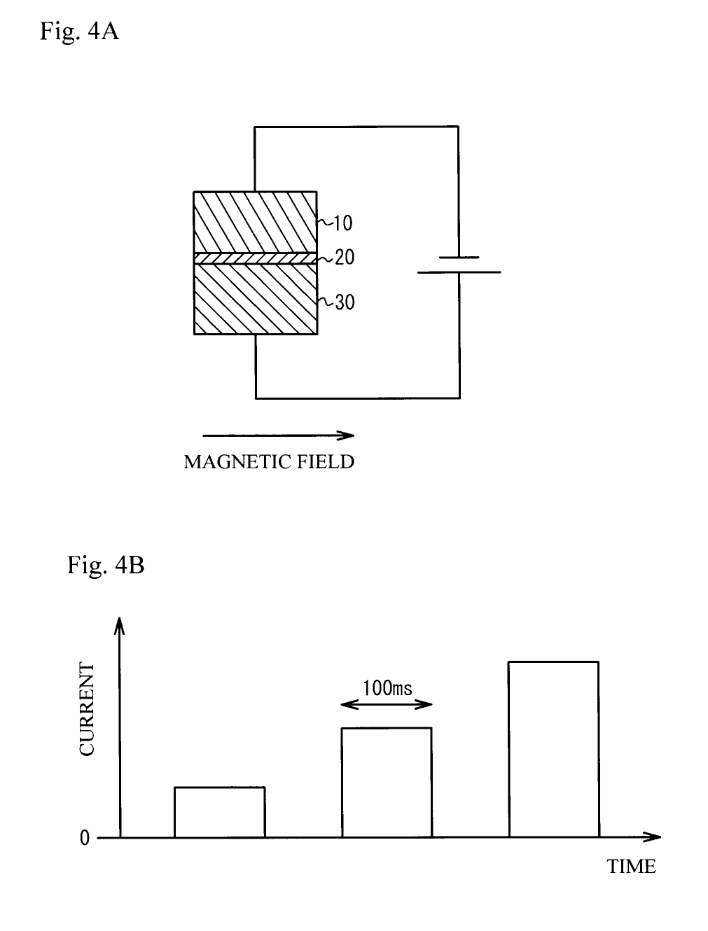

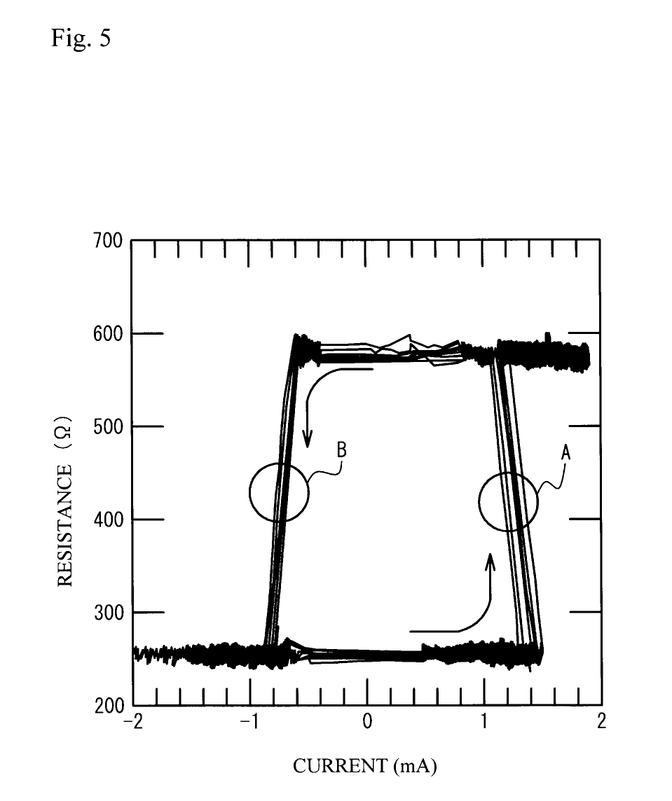

Next, the technique for measuring the thermal stability index Δ is described. A current is swept between the free layer 10 and the fixed layer 30 of a produced sample, and the magnetoresistance of the tunneling magnetoresistive device is measured. As shown in FIG. 4A, while a magnetic field of approximately 10 Oe is applied to the device in a direction parallel to the thin-film surface and to the longitudinal direction of the device, a current is applied to the device, with the free layer 10 being the negative side, and the fixed layer 30 being the positive side. As shown in FIG. 4B, the application of the current is performed with a pulse of 100 ms in width. FIG. 5 is a diagram showing the hysteresis characteristics of the current and resistance of the single-layer sample. In the regions A and B in FIG. 5, switching current distributions are observed. The thermal stability index Δ can be determined from the distributions. The theoretical formula of the switching current distributions can be expressed by the formula 3:

$$\frac{d P}{d {l}_{c}} ( \frac{{I}_{c}}{{I}_{c 0}} ) = Δ \frac{1}{{l}_{c 0}} \frac{{t}_{p}}{{τ}_{p \to AP}} exp ( - \frac{{t}_{p}}{{τ}_{P \to AP}} ) \\ {τ}_{P \to AP} = {τ}_{0} exp \{ Δ [ 1 - l {/}_{c 0} ] \} \qquad [ Formula 3 ]$$

where P represents the switching probability, I_{c} represents the switching current, I_{C0} represents the intrinsic switching current before subjected to thermal agitation, t_{P} represents the pulse current width, τ_{P-AP} represents the time required for the tunneling magnetoresistive device to switch from a parallel state to an antiparallel state, and τ₀ represents the reciprocal of the attempt frequency. With the use of the formula 3, the intrinsic switching current I_{C0} and the thermal stability index Δ can be determined from the switching current distributions.

Table 2 shows the intrinsic switching current density J_{C0} (I_{C0} per junction area) and the thermal stability index Δ of each of the samples calculated with the use of the formula 3 based on the switching current distributions in the regions A and B. Both J_{c0} and Δ in the table 2 represent mean values of parallel P to antiparallel AP switching (regions A) and from antiparallel AP to parallel P switching (regions B). Table 2 also shows mean values of the coercive force Hc. As can be seen from Table 2, the intrinsic switching current density J_{C0} is substantially the same among the samples. Although the coercive force Hc of the antiparallel-coupled sample is greater than the coercive force Hc of the parallel-coupled sample, the thermal stability index Δ of the parallel-coupled sample is greater than the thermal stability index Δ of the antiparallel-coupled sample. Accordingly, the parallel-coupled sample can achieve both a more desirable switching current and higher thermal resistance stability than the antiparallel-coupled sample and the single-layer sample.

TABLE 2

| | | PARALLEL | ANTIPARALLEL |
|---|---|---|---|
| | SINGLE LAYER | COUPLING | COUPLING |
| Jco (A/cm²) | 1.5 × 10⁷ | 1.3 × 10⁷ | 1.5 × 10⁷ |
| Δ | 31 | 25 | 37 |
| Hc (0e) | 21 | 55 | 37 |

### Second Embodiment

Samples that differ from the parallel-coupled sample of the first embodiment shown in FIG. 3 in that the film thickness of the second ferromagnetic film 16 is different from the film thickness of the first ferromagnetic film 12. In these samples, the film thickness of each conductive film 14 is 1.5 nm, and the film thicknesses of the second ferromagnetic films 16 are 1 nm and 4 nm (the sample having the 4-nm thick second ferromagnetic film 16 is the second embodiment). The other aspects of the samples are the same as the parallel-coupled sample of the first embodiment. Table 3 shows the results of evaluations made on the switching current density J_{C0} and the thermal stability index Δ of the samples in the same manner as in the first embodiment. Since the lots used for producing the samples are different from those used in the first embodiment, quantitative comparisons between the first embodiment and the second embodiment cannot be made.

TABLE 3

SECOND FERRO-
MAGNETIC FIELD
THICKNESS

| | 1.0 nm | 4.0 nm |
|---|---|---|
| Jco (A/cm²) | 2.4 × 10⁷ | 2.1 × 10⁷ |
| Δ | 41.5 | 60.6 |
| Hc (0e) | 133 | 243 |

As shown in Table 3, the intrinsic switching current density J_{C0} is substantially the same between the two samples. Where the film thickness (4 nm) of the second ferromagnetic film 16 is greater than the film thickness (2 nm) of the first ferromagnetic film 12, the coercive force Hc and the thermal stability index Δ are both greater than the coercive force Hc and the thermal stability index Δ obtained in the case where the film thickness of the second ferromagnetic film 16 is smaller (1 nm). Where the free layer 10 is a parallel-coupled layer, and the second ferromagnetic film 16 is thicker than the first ferromagnetic film 12, even higher thermal stability can be achieved.

In the following, the reason that higher stability can be achieved where the film thickness of the second ferromagnetic film 16 is equal to or greater than the film thickness of the first ferromagnetic film 12 is described. As shown in Table 1, where the free layer 10 is a parallel-coupled layer, the shape magnetic anisotropy energy Eᵤ^{shape} is proportional to the square of (M₁d₁+M₂d₂)/(d₁+d₁). To reduce the switching current, it is preferable to reduce the product M₁d₁ of the magnetization and the thickness of the first ferromagnetic film 12. More specifically, it is preferable to reduce the product M₁d₁ of the magnetization and the thickness of the first ferromagnetic film 12, and increase the product M₂d₂ of the magnetization and the thickness of the second ferromagnetic film 16 (or increase the magnetization and the thickness of the second ferromagnetic film 16). By doing so, the switching current can be reduced, and the thermal stability index Δ can be improved. The film thicknesses of the first ferromagnetic film 12 and the second ferromagnetic film 16 are relative to their volumes. Therefore, it is preferable that the product of the magnetization and the volume of the second ferromagnetic film 16 is larger than the product of the magnetization and the volume of the first ferromagnetic film 12. It is more preferable that the product of the magnetization and the volume of the second ferromagnetic film 16 is twice or more as large as the product of the magnetization and the volume of the first ferromagnetic film 12.

### Third Embodiment

Next, the film thickness of the conductive film 14 of a device in which the first ferromagnetic film 12 and the second ferromagnetic film 16 of the free layer 10 are coupled parallel to each other is described.

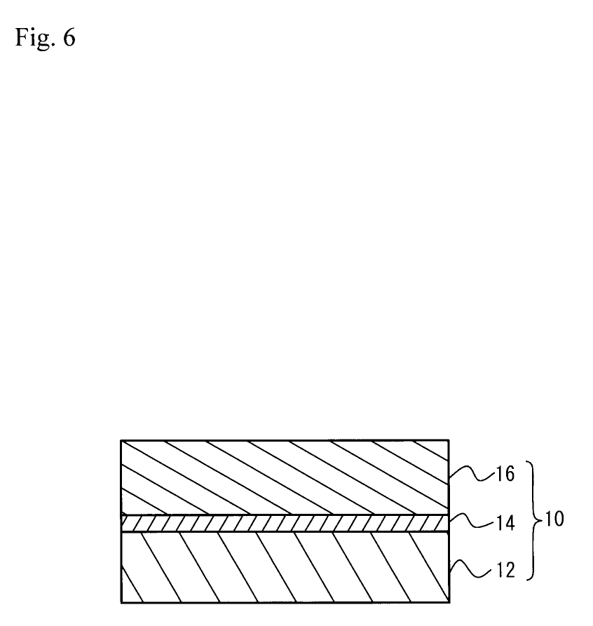

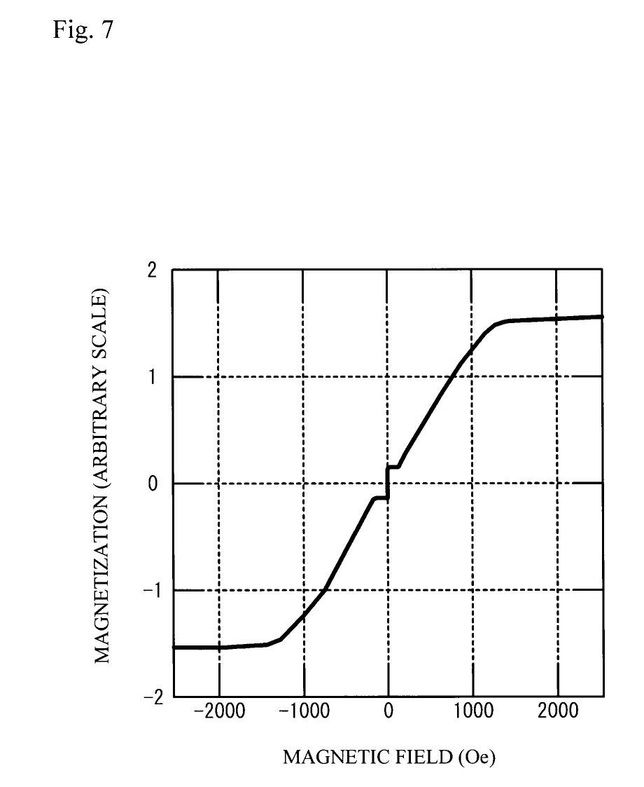

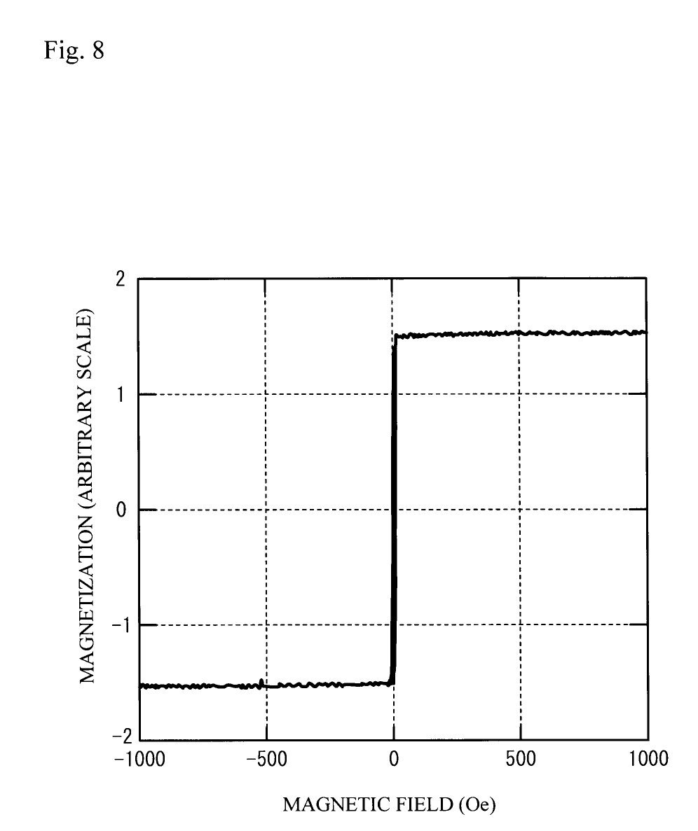

First, as shown in FIG. 6, samples A which correspond to the part of the free layer 10 of the first embodiment shown in FIG. 3 are prepared. FIG. 7 shows the field-magnetization curve of the sample A having a 1.1-nm-thick Ru film as the conductive film 14, 2-nm-thick CoFeB layers as the first ferromagnetic film 12 and the second ferromagnetic film 16. As can be seen from FIG. 7, the magnetic field Hₛₐₜ with which the magnetization reaches saturation is as large as 1 kOe or more, and strong antiparallel coupling is observed. FIG. 8 shows the field-magnetization curve of the sample A having a 1.3-nm thick Ru film as the conductive film 14. As can be seen from FIG. 8, like the magnetization curve of the single-layer sample, the magnetization curve sharply rises around the point where the magnetic field is zero, and the strength of the interlayer exchange coupling cannot be evaluated.

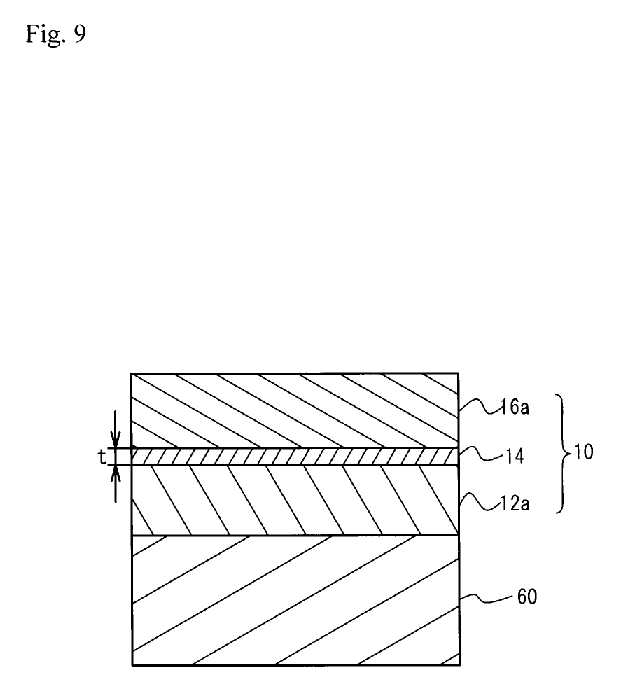

To counter this problem, samples B each having the structure shown in FIG. 9 are produced. In each of the samples B, a first ferromagnetic film 12a that is a 2.5-nm thick CoFe film is formed on a 15-nm thick PtMn film 60, a conductive film 14a that is a Ru film having a film thickness t is formed on the first ferromagnetic film 12a, and a second ferromagnetic film 16a that is a 3-nm thick CoFeB film is formed on the conductive film 14a. Each of the films is formed by a magnetron sputtering technique. Since the PtMn film 60 and the first ferromagnetic film 12a are exchange coupled in the samples B, the magnetization of the first ferromagnetic film 12a is not easily reversed. Accordingly, it becomes possible to evaluate the parallel coupling strength by measuring a loop shift in the magnetization-field curve.

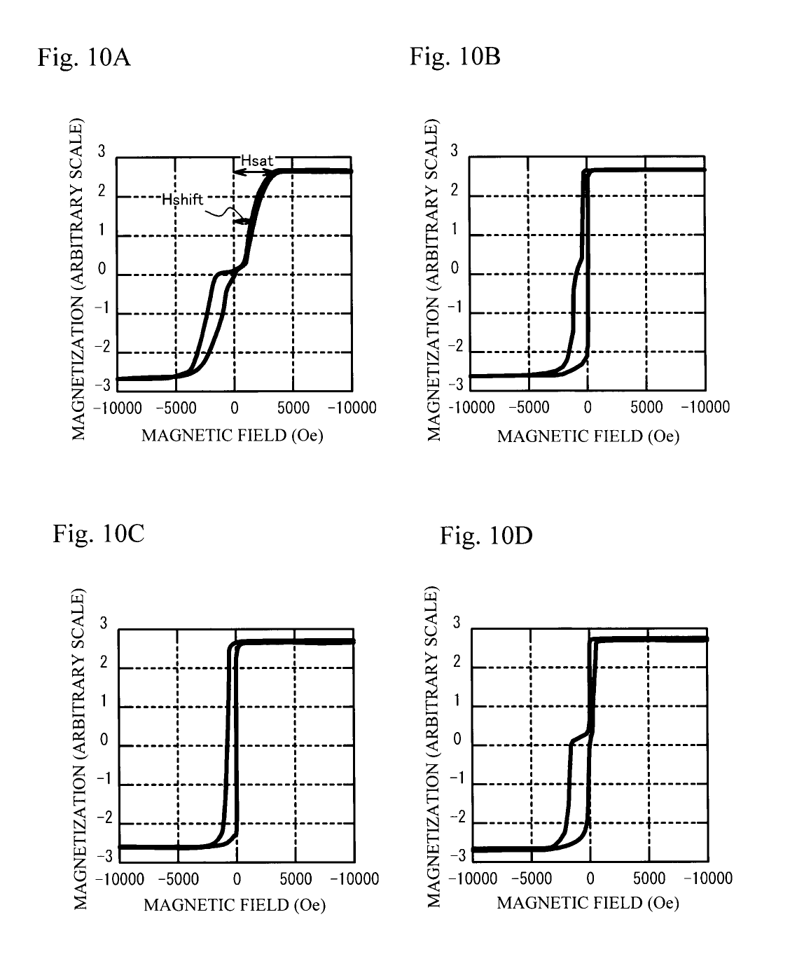

FIGS. 10A through 10D show the magnetization-field curves observed where the film thickness t of the conductive film 14 is 0.85 nm, 1.1 nm, 1.4 nm, and 2.0 nm. As shown in FIG. 10A, the strength of the magnetic field with which the magnetization reaches saturation is the saturation magnetic field Hₛₐₜ, and the strength of the magnetic field with which the magnetization is half the saturation magnetization is the loop shift H_{shift}. If hysteresis exists, the strength of the magnetic field at the center of the two curves is the saturation magnetic field Hₛₐₜ or the loop shift H_{shift}. In the case of parallel coupling, the saturation magnetic field Hₛₐₜ characteristically becomes smaller, and the loop shift H_{shift} characteristically becomes negative.

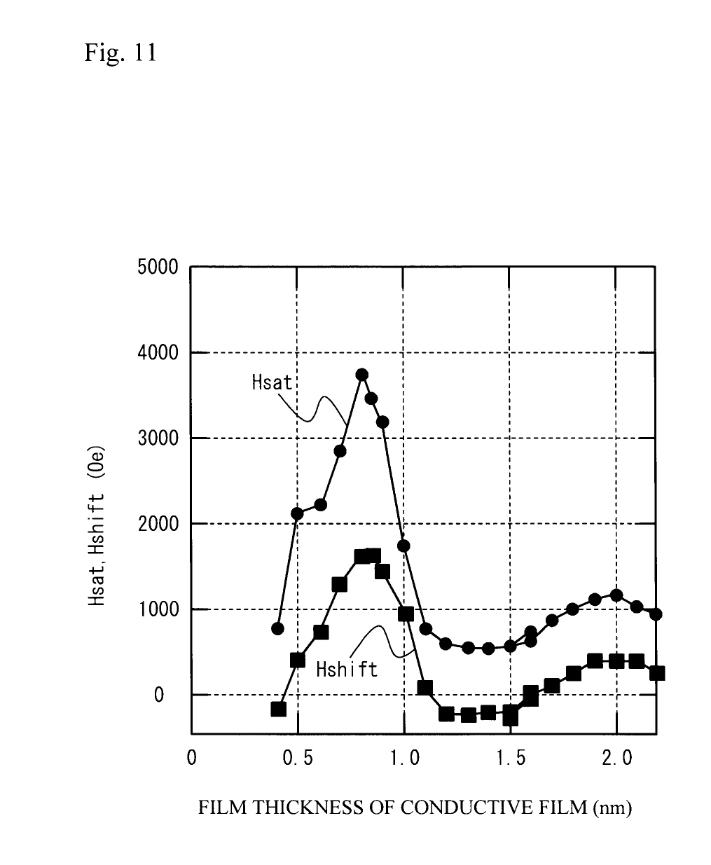

FIG. 11 shows the results of measurement carried out on the saturation magnetic field Hₛₐₜ and the loop shift H_{shift} in each of the samples B having the conductive films 14 of various film thicknesses t. Where the film thickness t is 0.8 nm, the saturation magnetic field Hₛₐₜ and the loop shift H_{shift} become largest, and the first ferromagnetic film 12a and the second ferromagnetic film 16a are coupled antiparallel to each other. On the other hand, where the film thickness t is in the range of 1.2 nm to 1.5 nm, the saturation magnetic field Hₛₐₜ is negative, and the first ferromagnetic film 12a and the second ferromagnetic film 16a are coupled parallel to each other. Since the samples B differ from the samples A in part of the ferromagnetic material, the film thickness of the conductive film 14 (Ru film) that realizes parallel coupling varies slightly between the samples B and the samples A.

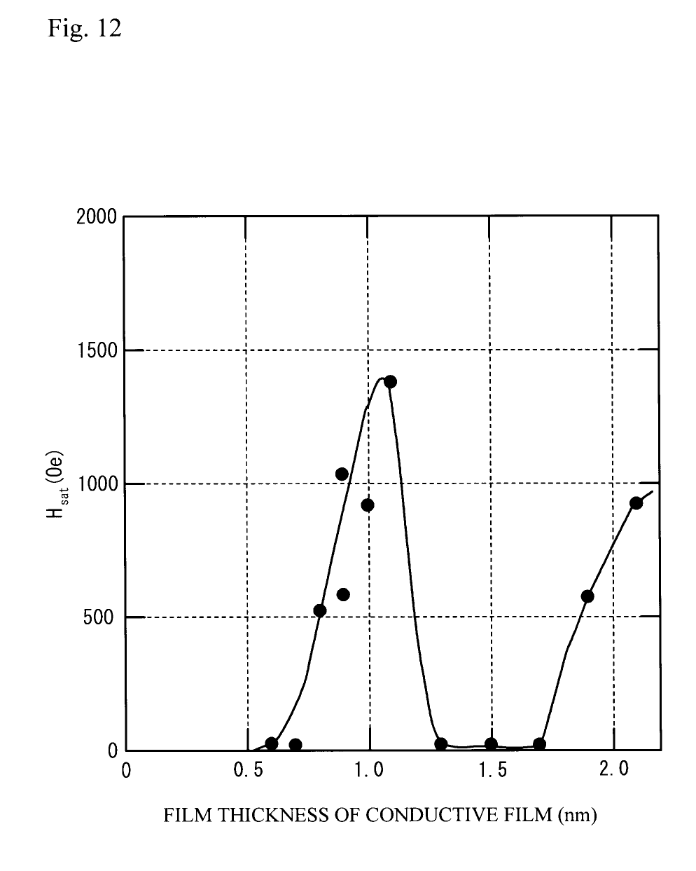

FIG. 12 shows the results of measurement carried out on the saturation magnetic field Hₛₐₜ of the samples A having the conducive films 14 of various film thicknesses t. The largest saturation magnetic field Hₛₐₜ obtained where the film thickness t of the conductive film 14 (Ru film) is 1.1 nm corresponds to the largest saturation magnetic field Hₛₐₜ obtained where the film thickness t of the conductive film 14 is 0.8 nm in the samples B. Accordingly, strong antiparallel coupling is observed where the film thickness t is 1.1 nm in the samples A. Likewise, the film thickness t with which parallel coupling is observed in the samples A is also slightly greater than in the samples B. The reduction in the saturation magnetic field Hₛₐₜ where the film thickness is in the range of 1.3 nm to 1.7 nm in the samples A corresponds to the minimum value of the saturation magnetic field Hₛₐₜ where the film thickness t is in the range of 1.1 nm to 1.5 nm in the samples B shown in FIG. 11. In short, parallel coupling is observed where the film thickness t is in the range of 1.3 to 1.7 nm in the samples A, though the strength of the coupling is not apparent. In view of this, the magnetization of the first ferromagnetic film 12 and the magnetization of the second ferromagnetic film 16 are coupled parallel to each other in the samples having the conductive films 14 of 1.3 nm and 1.5 nm in the film thickness t in the free layer 10 in the first and second embodiments. On the other hand, in the sample having the conductive film 14 of 1.1 nm in film thickness t in the free layer 10 in the first embodiment, the magnetization of the first ferromagnetic film 12 and the magnetization of the second ferromagnetic film 16 are coupled parallel to each other.

As shown in FIGS. 11 and 12, the film thickness t of the conductive film 14 that causes parallel coupling varies slightly with the ferromagnetic materials combined. This is probably because the interfacial diffusion between the ferromagnetic thin films and the conductive film 14 (Ru film) varies with the combination, the thin-film growth of the Ru film also varies with the ferromagnetic material of the base layer.

As described in the first embodiment, where the free layer 10 is formed on the tunneling insulating film 20, the preferred film thickness of the conductive film 14 varies with the material of the first ferromagnetic film 12. Therefore, where a Ru film is used as the conductive film 14, and a CoFeB film is used as the first ferromagnetic film 12, it is preferable that the film thickness t of the conductive film 14 is in the range of 1.3 nm to 1.7 nm, so as to realize parallel coupling between the first ferromagnetic film 12 and the second ferromagnetic film 16. It is preferable that the second ferromagnetic film 16 is also a CeFeB film. The film thickness t suitable for realizing the parallel coupling between the first ferromagnetic film 12 and the second ferromagnetic film 16 is hardly affected by the film thicknesses of the first ferromagnetic film 12 and the second ferromagnetic film 16, because of the above mentioned reasons.

### Fourth Embodiment

The same experiments are carried out in a different manner. A parallel-coupled sample and an antiparallel-coupled sample are formed independently of each other. In the parallel-coupled sample, the film thickness of the conductive film 14 is 1.5 nm. In the antiparallel-coupled sample, the film thickness of the conductive film 14 is 1.1 nm. The other aspects of the structures of those samples are the same as those of the parallel-coupled sample and the antiparallel-coupled sample of the first embodiment.

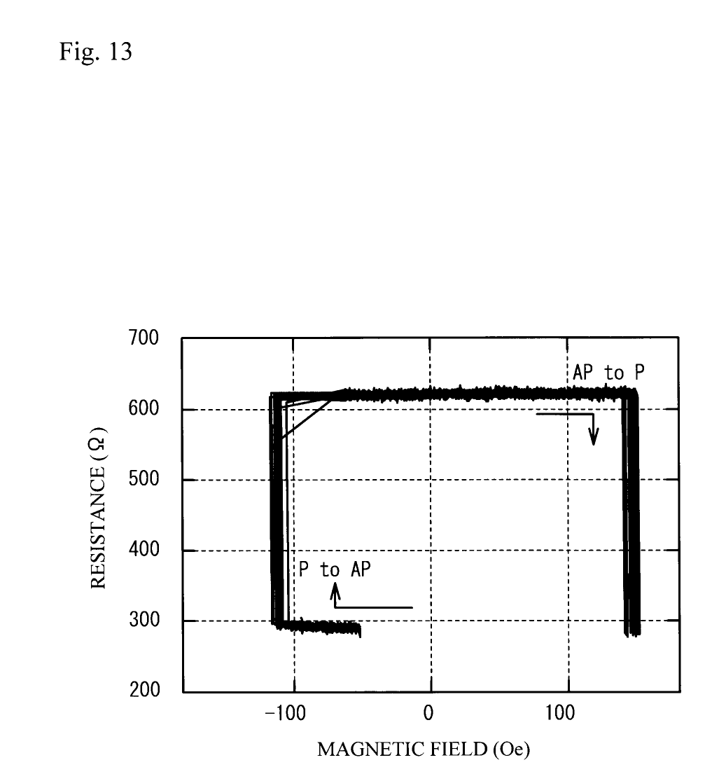

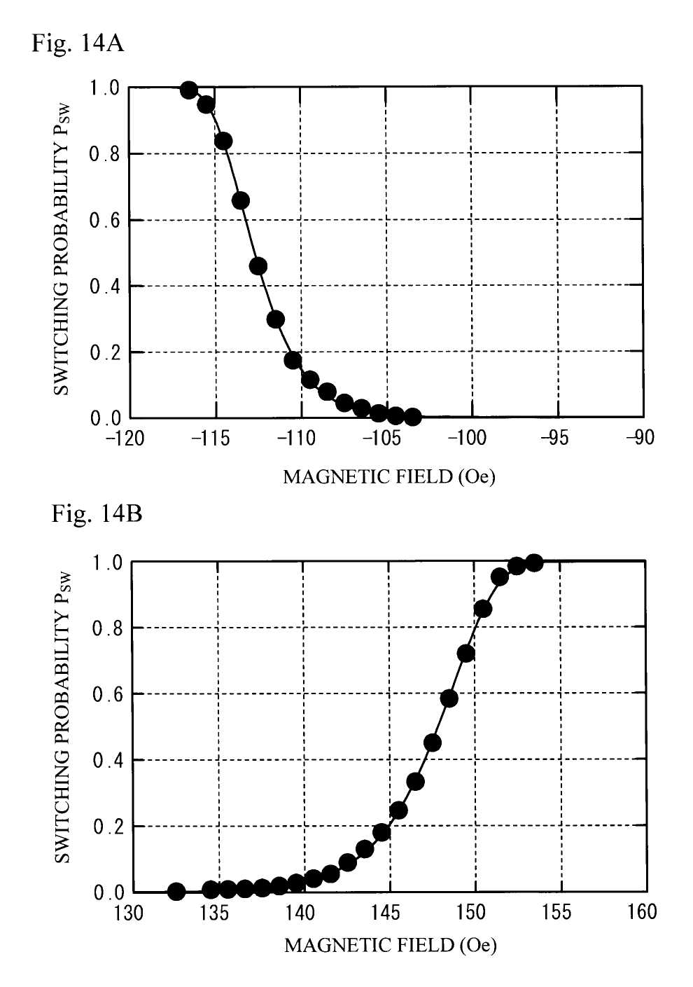

Measurement by a magnetization reversal technique is carried out as follows. FIG. 13 is a graph showing the resistance of a tunneling magnetoresistive device with respect to a magnetic field. As shown in FIG. 13, a magnetic field sweep is performed 800 times. The magnetic field sweep rate v is 21.3 Oe/s. When a magnetic field sweep is performed more than once as shown in FIG. 13, the magnetic field that switches from a parallel state P to an antiparallel state AP, or from an antiparallel state AP to a parallel state P, varies each time. FIG. 13 shows an example of the parallel-coupled sample. FIG. 14A is a graph showing the switching probability P_{SW} that the magnetic field switches from a parallel state to an antiparallel state. In FIG. 14A, the probability that the magnetic field is in an antiparallel state at −105 Oe is almost zero. The probability that the magnetic field is in an antiparallel state at −117 Oe is almost 100%. FIG. 14B is a graph showing the switching probability P_{SW} that the magnetic field switches from an antiparallel state to a parallel state.

The theoretical formula of the switching probability P_{SW} is expressed by the following formula 4:

P_{SW}=1−exp{(−tₚ/t₀)×exp(−Δ×(1−H/H₀₀)²)} [Formula 4]

where tₚ represents the ratio between the mean value of H_{c} and the magnetic field sweep rate v, and t₀ represents the reciprocal of the attempt frequency. Based on the results shown in FIGS. 14A and 14B, the thermal stability indexes Δ of the parallel-coupled sample and the antiparallel-coupled sample, and the coercive force at absolute zero temperature H_{C0} are determined according to the formula 4. The results of the measurement are shown in Table 4. The thermal stability index Δ and the coercive force at absolute zero temperature H_{C0} represent the mean values at which a parallel state is changed to an antiparallel state, and an antiparallel state is changed to a parallel state.

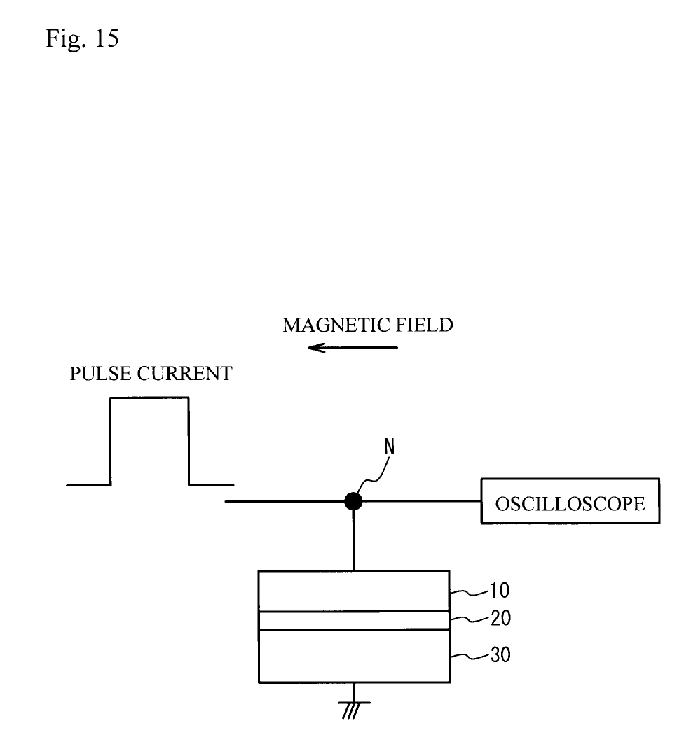

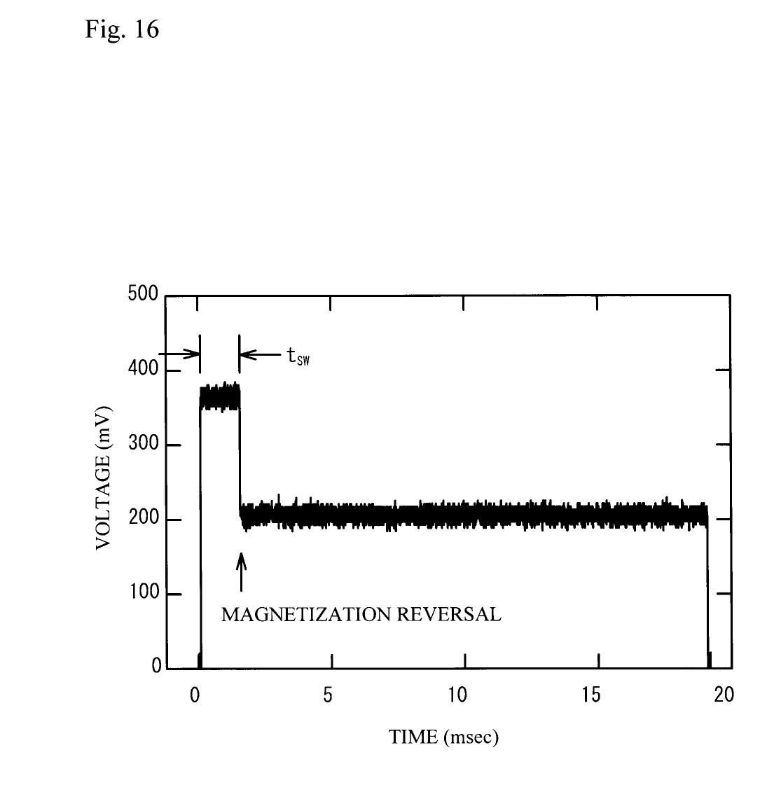

Measurement by a spin-injection magnetization reversal technique is carried out in the following manner. FIG. 15 is a schematic view showing the measurement by a spin-injection magnetization reversal technique. As shown in FIG. 15, the fixed layer 30 of a tunneling magnetoresistive device is grounded while a magnetic field is being applied, and a pulse current is introduced to the free layer 10. The voltage of a node N of the free layer 10 is observed with an oscilloscope. FIG. 16 is a graph showing the voltage V of the node N observed with the oscilloscope with respect to time. The pulse current I is 0.7 mA, and the magnetic field H is 120 Oe. As shown in FIG. 16, a magnetization reversal from an antiparallel state to a parallel state is observed at time t_{sw}.

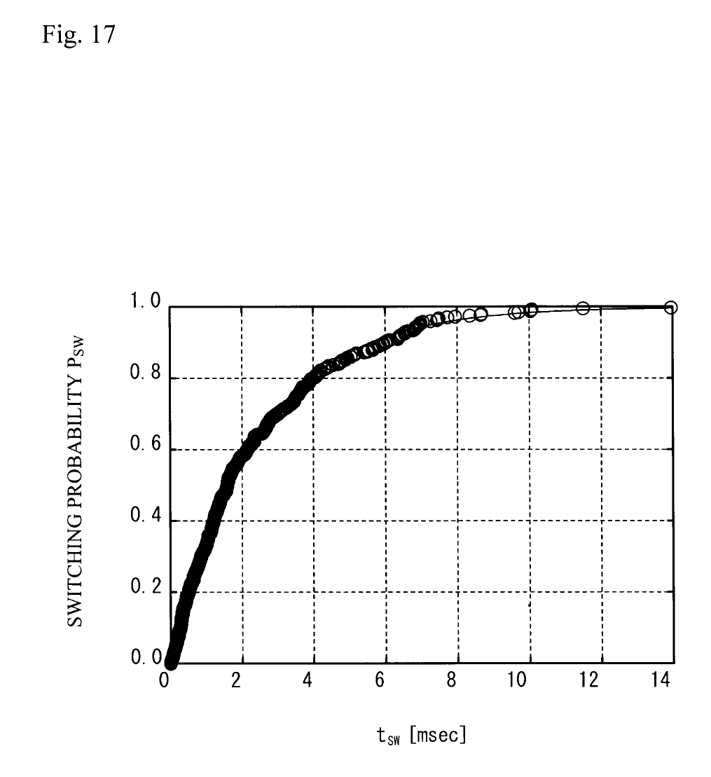

FIG. 17 is a graph showing the switching probability P_{SW} with respect to time t_{SW} in a case where the observation illustrated in FIG. 16 is performed several hundreds of times. The theoretical formula of the switching probability P_{SW} is the following formula 5:

P_{SW}=1−exp[(−tₚ/t₀)×exp(−Δ_{eff})] [Formula 5]

where Δ_{eff} represents the effective thermal stability. According to this formula, the effective thermal stability Δ_{eff} in the case of an current I_{c} and a magnetic field H is determined. The effective thermal stability Δ_{eff} is expressed by the following formula 6 and formula 7:

Δ_{eff}=Δ_{eff}(I)×(1−H/H_{C0})² [Formula 6]

Δ_{eff}(I)=Δ×(1−I_{C}/I_{C0}) [Formula 7]

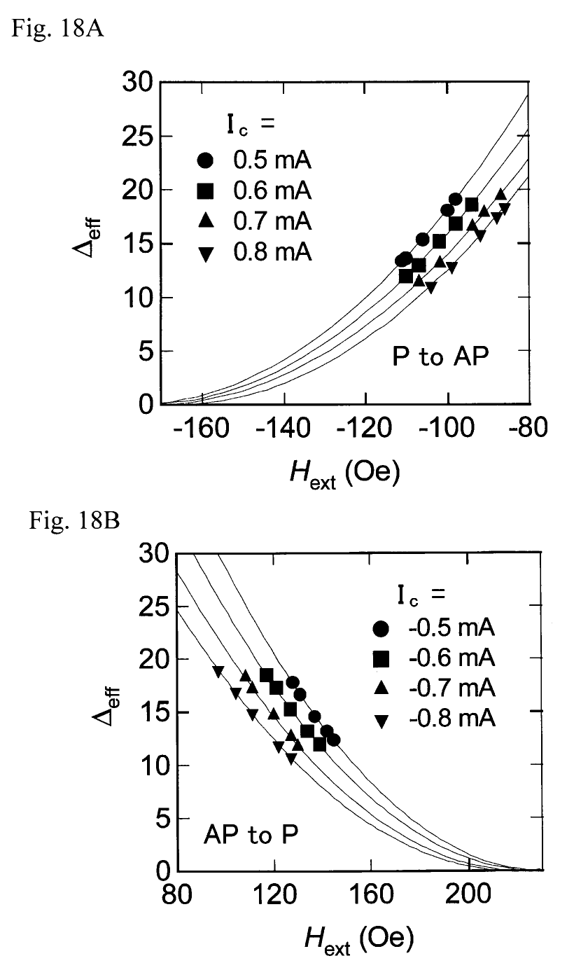

The pulse current I_{c} is set at ±0.5 mA, ±0.6 mA, ±0.7 mA, and ±0.8 mA, and the magnetic field is varied at ten points including positive points and negative points for each of the current values. The effective thermal stability Δ_{eff} is then measured. FIGS. 18A and 18B are graphs showing the effective thermal stability Δ_{eff} with respect to the magnetic field Hₑₓₜ in the case of switching from parallel P to antiparallel AP state (P to AP switching) and in the case of switching from antiparalle AP to parallel P state (AP to P switching), respectively. In FIGS. 18A and 18B, symbols represent experimental results at each current I_{c} and lines represent theoretical fit based on formula 6. From the theoretical fit, we can obtain a set of ≢6_{eff}(I) and H_{C0} at each current Ic.

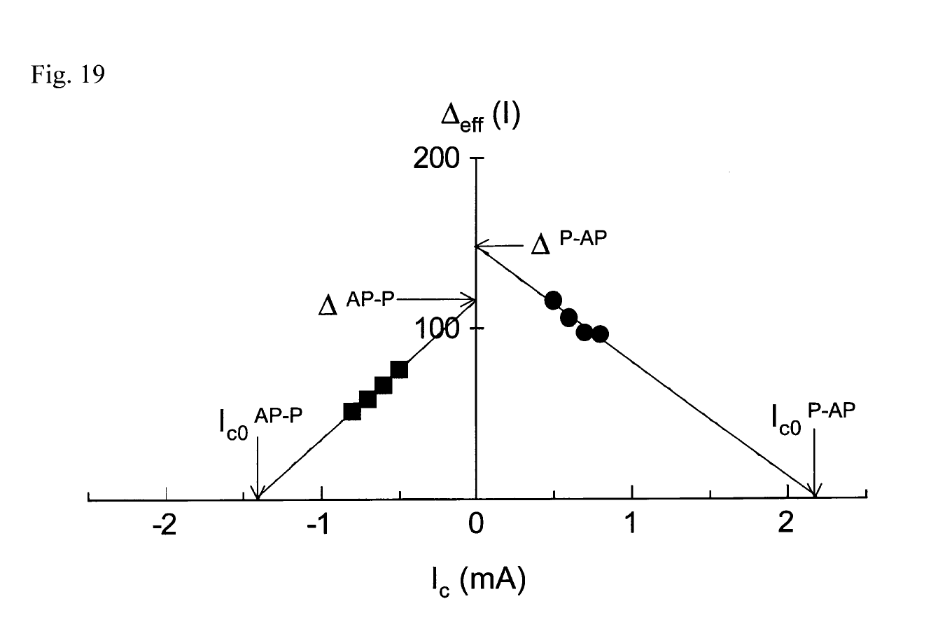

FIG. 19 is a graph showing the effective thermal stability Δ_{eff}(I) with respect to current I_{c} for both switching from parallel P to antiparallel AP and switching from anitiparallel AP to parallel P. Circles represent the Δ_{eff}(I) values for P to AP switching obtained in the theoretical fit based on formula 6 shown in FIG. 18A. Squares represent the Δ_{eff}(I) values for AP to P switching obtained in the theoretical fit based on formula 6 shown in FIG. 18B. Lines of FIGS. 18A and 18B represent theoretical fit based on formula 7. According to the formula 7, the thermal stability index Δ^{P-AP} and the switching current I_{C0}^{P-AP} for P to AP switching can be determined from the intercepts of line in the plus region of the current I_{C} as shown in FIG. 19. Similarly, the thermal stability index Δ^{AP-P} and the switching current I_{C0}^{AP-P} for AP to P switching can be obtained from the intercepts of line in the minus region of the current I_{C} as shown in FIG. 19. The mean values of intrinsic switching current density J_{C0}=(½)(|I_{C0}^{AP-P}|+|I_{C0}^{P-AP}|)/A (A is junction area), the mean values of thermal stability index Δ=(Δ^{AP-P}+Δ^{P-AP})/2, and the mean values of the coercive force at absolute zero temperature H_{C0} are shown in Table 4. FIGS. 17 through 19 are graphs for explaining the measurement technique, and do not correspond to the numeric values shown in Table 4.

As shown in Table 4, with the use of different samples and different evaluation technique from those of the first embodiment, it is confirmed that the parallel-coupled sample has a greater thermal stability index Δ than the antiparallel-coupled sample.

TABLE 4

| EVALUATION | | ANTIPARALLEL | PARALLEL |
|---|---|---|---|
| TECHNIQUE | ITEM | COUPLING | COUPLING |
| MAGNETIC | Δ | 96 | 122 |
| FIELD | H_{co} (0e) | 335 | 233 |
| REVERSAL | | | |
| SPIN-INJECTION | J_{co} (A/cm²) | 1.7 × 10⁷ | 1.9 × 10⁹ |
| MAGNETIZATION | Δ | 83 | 252 |
| REVERSAL | H_{co} (0e) | 310~315 | 197 |

### Fifth Embodiment

As a modification of the second embodiment, samples in which the film thickness of the second ferromagnetic film 16 is 1 nm, 2 nm, and 4 nm are formed. As in the fourth embodiment, the intrinsic switching current I_{C0}, the thermal stability index Δ, and the coercive force at absolute zero temperature H_{C0} are measured by a spin-injection magnetization reversal technique. Also, the thermal stability index Δ and the coercive force at absolute zero temperature H_{C0} of the same samples are measured by a magnetic field reversal technique as in the fourth embodiment. The results of the measurements are shown in Table 5. As shown in Table 5, where the second ferromagnetic film is thicker, a greater thermal stability index Δ can be achieved with the use of a different sample and different evaluation technique from the second embodiment. As can be seen from Table 5, it is preferable that the product of the magnetization and the volume of the second ferromagnetic film 16 is equal to or larger than the product of the magnetization and the volume of the first ferromagnetic film 12.

TABLE 5

| | | SECOND FERROMAGNETIC | | |
|---|---|---|---|---|
| EVALUATION | | FIELD THICKNESS | | |
| TECHNIQUE | ITEM | 1.0 nm | 2.0 nm | 4.0 nm |
| MAGNETIC | Δ | 70 | 122 | 254 |
| FIELD | H_{co} (0e) | 205 | 233 | 328 |
| REVERSAL | | | | |
| SPIN-INJECTION | J_{co} (A/cm²) | 1.7 × 10⁷ | 1.9 × 10⁷ | 1.9 × 10⁷ |
| MAGNETIZATION | Δ | 57 | 125 | 373 |
| REVERSAL | H_{co} (0e) | 180 | 197 | 243 |

### Sixth Embodiment

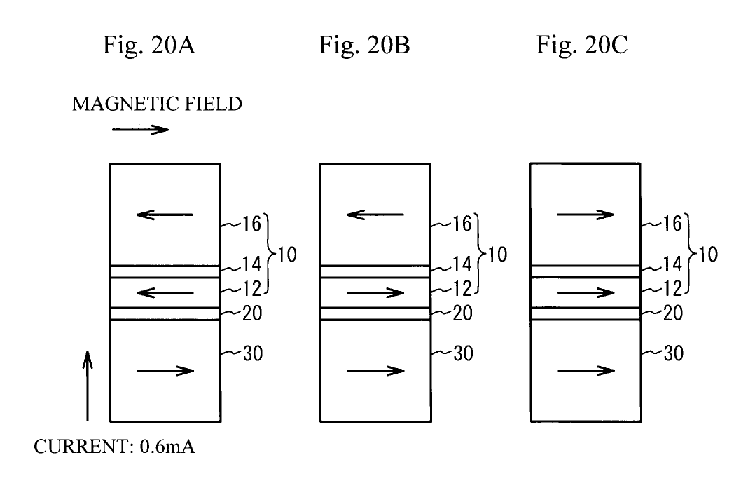

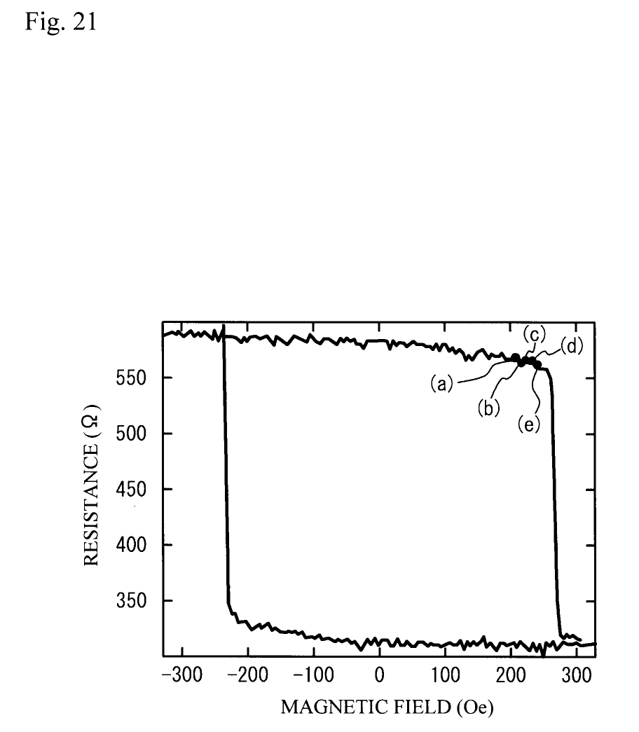

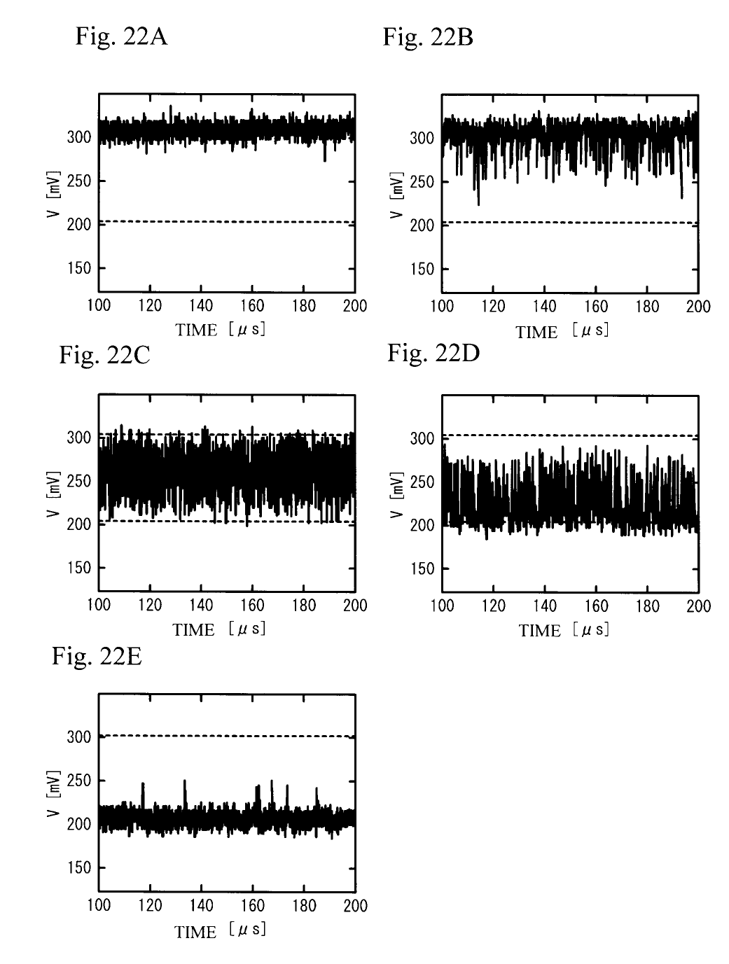

A sixth embodiment of the present invention is an example in which the film thickness of the second ferromagnetic film 16 of the second embodiment is further increased. FIGS. 20A through 20C are schematic views of a sample that is produced in this embodiment. The film thickness of the first ferromagnetic film 12 is 2 nm, and the film thickness of the second ferromagnetic film 16 is 6 nm in this embodiment. The first ferromagnetic film 12 and the second ferromagnetic film 16 are parallel coupled. The other aspects of this embodiment are the same as those of the second embodiment, and therefore, explanation of them is omitted herein. As shown in FIG. 20A, a magnetic field is applied, and a current of 0.6 mA is applied to a tunneling magnetoresistive device. The resistance of the tunneling magnetoresistive device is then measured. FIG. 21 is a graph showing the resistance with respect to the magnetic field. As can be seen from FIG. 21, excellent hysteresis characteristics are obtained. FIGS. 22A through 22E are graphs showing the voltage V applied to the tunneling magnetoresistive device, with respect to time, at the points (a) through (e) shown in FIG. 21. The magnetic fields in the examples shown in FIGS. 22A through 22E are 208 Oe, 215 Oe, 224 Oe, 233 Oe, and 242 Oe, respectively.

In FIG. 22A, the voltage V is approximately 300 mV. This indicates that both magnetizations of the first ferromagnetic film 12 and the second ferromagnetic film 16 of the free layer 10 are in an antiparallel state with respect to the magnetization direction of the fixed layer 30, as shown in FIG. 20A. In FIG. 22E, the voltage V is approximately 200 mV. This indicates that both magnetizations of the first ferromagnetic film 12 and the second ferromagnetic film 16 of the free layer 10 are in a parallel state with respect to the magnetization direction of the fixed layer 30, as shown in FIG. 20C. In FIGS. 22B through 22D, the voltage V oscillates between 300 mV and approximately 200 mV. The possible reason for this voltage oscillation is that the magnetization of the second ferromagnetic film 16 is not easily reversed as shown in FIG. 20B, and the magnetization state repeatedly switches between the state shown in FIG. 20A and the state shown in FIG. 20B.

As described above, in accordance with the second embodiment, it is preferable that the second ferromagnetic film 16 is thick, or the product of the magnetization and the volume of the second ferromagnetic film 16 is large. In the sixth embodiment, on the other hand, it has become apparent that the magnetization of the first ferromagnetic film 12 returns to the original state after a magnetization reversal, if the second ferromagnetic film 16 is too thick or the product of the magnetization and the volume is too large. In view of these facts, it is preferable that the product of the magnetization and the volume of the second ferromagnetic film 16 is smaller than three times the product of the magnetization and the volume of the first ferromagnetic film 12.

Although a few preferred embodiments of the present invention have been shown and described, it would be appreciated by those skilled in the art that changes may be made in these embodiments without departing from the principles and spirit of the invention, the scope of which is defined in the claims and their equivalents.

The present application is based on Japanese Patent Application Nos. 2008-222753 filed on Aug. 29, 2008 and 2009-158982 filed on Jul. 3, 2009, the entire disclosure of which is hereby incorporated by reference.

What is claimed is:

1. A tunneling magnetoresistive device comprising:
a fixed layer that includes a ferromagnetic material;
a tunneling insulating film that is provided in contact with the fixed layer; and
a free layer that includes a first ferromagnetic film provided in contact with the tunneling insulating film, a second ferromagnetic film whose magnetization is coupled parallel to the magnetization of the first ferromagnetic film, and a conductive film interposed between the first ferromagnetic film and the second ferromagnetic film.

2. The tunneling magnetoresistive device as claimed in claim 1, wherein a product of the magnetization and a volume of the second ferromagnetic film is equal to or greater than a product of magnetization and a volume of the first ferromagnetic film.

3. The tunneling magnetoresistive device as claimed in claim 1, wherein a product of the magnetization and a volume of the second ferromagnetic film is twice or more as large as a product of magnetization and a volume of the first ferromagnetic film.

4. The tunneling magnetoresistive device as claimed in claim 3, wherein the product of the magnetization and the volume of the second ferromagnetic film is smaller than three times the product of the magnetization and the volume of the first ferromagnetic film.

5. The tunneling magnetoresistive device as claimed in claim 1, wherein the conductive film is a Ru film.

6. The tunneling magnetoresistive device as claimed in claim 5, wherein the first ferromagnetic film is a CoFeB film.

7. The tunneling magnetoresistive device as claimed in claim 5, wherein the first ferromagnetic film and the second ferromagnetic film are CoFeB films.

8. The tunneling magnetoresistive device as claimed in claim 7, wherein a film thickness of the conductive film is in the range of 1.3 nm to 1.7 nm.

9. The tunneling magnetoresistive device as claimed in claim 2, wherein the tunneling insulating film is a magnesium oxide film.

10. The tunneling magnetoresistive device as claimed in claim 2, wherein a shape magnetic uniaxial anisotropy energy of the free layer is greater than an energy obtained by subtracting the shape magnetic uniaxial anisotropy energy from a magnetic uniaxial anisotropy energy of the free layer.
